(19) United States
(12) Patent Application Publication
(10) Pub. No.: US 2008/0198762 A1
(43) Pub. Date: Aug. 21, 2008

(54) Cross-subnet-nodes subnet node device detection method

(75) Inventors: Yuan Bai, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/707,873

(22) Filed: Feb. 20, 2007

(51) Int. Cl. H04L 12/28

(52) U.S. Cl. 370/254

(57) ABSTRACT

A cross-subnet-nodes network node device detection method is provided, including the steps of disposing a boot module in each network node devices in an arbitrary subnet of a network; activating the first subnet node device to be a registry server and recording its registry information; activating other network node devices in the subnet, and dispatching the registry information of these devices to the registry server and recording it; searching for the IP address of the first available network node device in the subnet; issuing a command for searching the registry server, issuing a registry information command by the first available network node device, and obtaining the IP address of the registry server and sending it back to the discovery server; and upon receiving a command for searching the network node devices by the registry server, transmitting the information of the node devices in a subnet back to the discovery server.

### BACKGROUND

1. Field of Invention

The invention relates to a network node device detection method, and in particular to a cross-subnet-nodes network node device detection method, that is capable of searching through the network node devices on all the subnet nodes of subnets in a large scale network environment rapidly and efficiently.

2. Related Art

Presently, in a network management system, the first and most essential task is to have the capability of searching and finding the network node devices in a network, thus being able to carry out the management operations required. In general, this kind of search is realized through a standard or defined socket interface as based on the Transmission Control Protocol/Internet Protocol (TCP/IP) (for example, as shown in FIG. 1, a discovery server 10 is connected directly to a network node device 100 in a subnet 192,168.2.0 through TCP/IP. Similarly, the connections of the network node device 200 and the network node device 300 to the discovery server are also carried out respectively through TCP/IP). However, due to the intrinsic property and limitations of TCP/IP, in case that a discovery server 10 is required to search for an Internet Protocol (IP) address of a network node device that is not existed in the subnet, then a 20-second Time-Out will appear. In an ordinary network system of category C (Internet is classified into 5 categories of A, B, C, D, and E according to the IP address), for the worst case, there are 255 time-outs each lasting 20 seconds, thus the time required for this kind of search for an IP address that does not exist in a subnet might be still acceptable to the user. However, for the network system of category B, the number of IP addresses is 255 times 255, thus the low search efficiency and overly long waiting time caused by the time-outs while executing such a search is beyond the tolerance and endurance of any user.

Though, presently, in some network systems, a rapid search of network node device may be realized by means of Multicast. However, for the routes in a plurality of subnets, the multicast function is forbidden to use within the limits of an enterprise; otherwise, its utilization tends to create broadcast storm, hereby paralyzing the whole network system. Therefore, the application of multicast in performing the search of network node devices may only be applied to an enterprise in a simple network.

### SUMMARY OF THE INVENTION

In view of the above-mentioned problems and drawbacks of the prior art, the object of the invention is to provide a cross-subnet-nodes network node device detection method, that is capable of performing a rapid search for the network node devices on a plurality of nodes in any one of the subnets of a large scale network environment.

In the invention, a cross-subnet-nodes network node device detection method is disclosed, including the following steps.

Firstly, disposing a boot module in a network node device on each subnet nodes in an arbitrary subnet of a network. Next, activating the network node device of a first subnet node in the subnet, and activating the network node device as a Registry Server by means of a boot module of the network node device, and recording the Registry Information of the network node device. Then, activating the network node devices of other subnet nodes in the subnet, and dispatching the registry information of these network node devices to the registry server of the first subnet node and recording it through the boot modules of these network node devices. Subsequently, searching and obtaining the IP address of the network node device on a first available subnet node in the subnet through a verification process, when the discovery server is required to search all the network node devices in a subnet. Moreover, issuing a command for inquiring registry server to the network node device of the first available subnet node by the discovery server, and issuing a registry information command in turn by the network node device on the first available subnet node through the boot module, and obtaining the IP address of the registry server and sending it back to the discovery server. And finally, issuing a command for searching all the network node devices in the subnet to the registry server by the discovery server, and upon receiving the command for searching all the network node devices, transmitting back the registry information of all the network node devices in a subnet to the discovery server by the registry server through the boot module.

Summing up the above, the invention provides a cross-subnet-nodes network node device detection method having the following advantages.

In the invention, a User Datagram Protocol (UDP) (a kind of conventional communication protocol utilized on a TCP/IP network having the characteristics that, a connection is not required to be established in advance in executing data transmission, namely, it is not required to have a so-called hand shake protocol. In the implementation of UDP, packets are sent one by one to other end of a data chain, and the data transmission is toward the entire network, so that any of the respective computers in a local area network may receive the same data) broadcasting is utilized, and with the addition of boot module, thus in the search of a network node device on a plurality of nodes in a multiple subnets large scale network environment, there is no need to perform a direct search for the respective network node devices as based on TCP/IP, hereby avoiding and eliminating the 20-second Time-Out required in searching for an invalid IP addresses by means of TCP/IP in a conventional manner. As such, a discovery server may obtain the pertinent information of all the network node devices in a subnet in a time period originally spent on executing one or two search commands in the conventional manner, thus providing a rapid network node device detection method for a multi-subnet large scale network environment, hereby increasing the search efficiency and reducing the waiting time of the user significantly.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the invention, and wherein:

FIG. 1 is a system block diagram of the network structure for the implementation of the network node device detection method according to prior art;

FIG. 2 is a flowchart of the steps of the cross-subnet-nodes network node device detection method according to an embodiment of the invention;

FIG. 3 is a flowchart of the steps of operating a boot module in a cross-subnet-nodes network node device detection method according to an embodiment of the invention;

FIG. 4 is a system block diagram of the network structure for the implementation of the cross-subnet-nodes network node device detection method according to an embodiment of the invention; and

FIGS. 5 to 9 show the various groups of the steps of operation flow in carrying out the cross-subnet-nodes network node device detection method according to an embodiment of the invention.

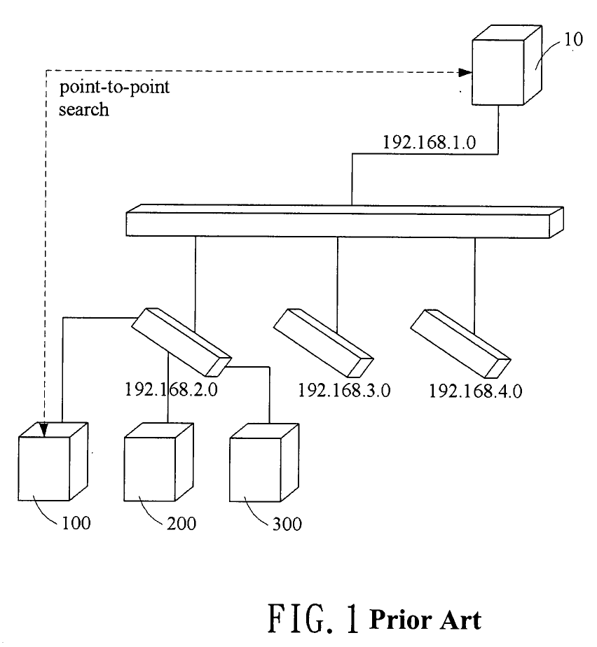

### DETAILED DESCRIPTION OF THE INVENTION

The purpose, construction, features, and functions of the invention can be appreciated and understood more thoroughly through the following detailed description with reference to the attached drawings.

In the following, the preferred embodiments of the invention will be described in detail together with the attached drawings.

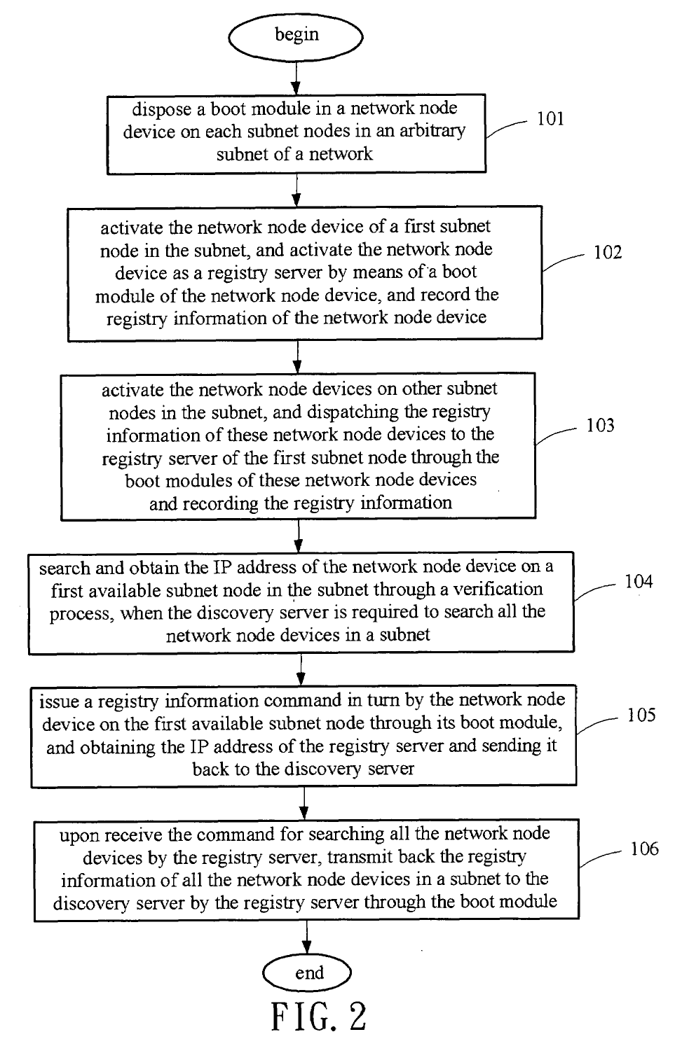

For a description of the cross-subnet-nodes network node device detection method of the invention, refer to FIG. 2. FIG. 2 is a flowchart of the steps of the cross-subnet-nodes network node device detection method, including the following steps:

Firstly, disposing a boot module in a network node device on each subnet nodes in an arbitrary subnet of a network (step S101);

Next, activating the network node device of a first subnet node in the subnet, and activating the network node device as a registry server by means of a boot module of the network node device, and recording the registry information of the network node device (step S102);

Then, activating the network node devices on other subnet nodes in the subnet, and dispatching the registry information of these network node devices to the registry server of the first subnet node through the boot modules of these network node devices and recording the registry information (step S103). Wherein, the registry information of the network node devices of other subnet nodes is recorded by the registry server of the first subnet node in its internal memory table.

Subsequently, searching and obtaining the IP address of the network node device on a first available subnet node in the subnet through a verification process, when the discovery server is required to search all the network node devices in a subnet (step 104). Wherein, the verification process is realized through an echo check procedure by making use of the Internet Control Message Protocol (ICMP). The ICMP is an extension version of Internet Protocol, that is utilized to realize the communication between a Gateway and a Host, and is used to generate the IP related error messages, test packets, and explanation messages, etc. In the messages of ICMP, the function of Ping command is to utilize ICMP to test the line connection conditions of Internet through the echo check procedure. Therefore, the utilization of ICMP echo check procedure may effectively eliminate the necessity of having to search through each of the respective network node devices for an invalid IP address, thus eliminating a time-out of 20 seconds, as such raising the search efficiency significantly. This technology belongs to the prior art, and will not repeated here in detail for brevity.

Moreover, issuing a command for searching registry server to the network node device of the first available subnet node by the discovery server, issuing a registry information command in turn by the network node device on the first available subnet node through its boot module, and obtaining the IP address of the registry server and sending it back to the discovery server (step 105).

And finally, issuing a command for searching all the network node devices in the subnet to the registry server by the discovery server, and upon receiving the command for searching all the network node devices by the registry server, transmitting back the registry information of all the network node devices in a subnet to the discovery server by the registry server through the boot module (step 106), thus obtaining the related information of the network node devices of all the subnet nodes in the subnet.

Furthermore, in the cross-subnet-nodes network node device detection method mentioned above, it has to be emphasized that, the registry information of the network node device of the various subnet nodes includes the information of: the IP address of the network node device, the type of node, and the type of the supportive network connection protocol. In addition, the registry information of the network node device of the various subnet nodes is transmitted and received by making use of Multi-Cast Registry Packets.

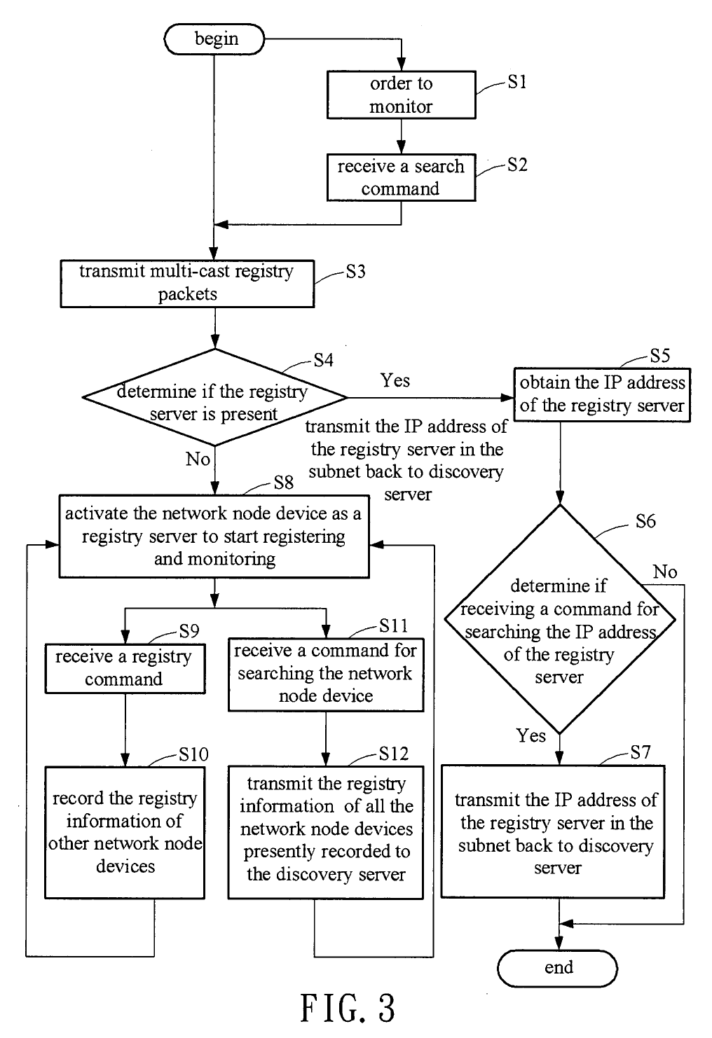

Now refer to FIG. 3. FIG. 3 is a flowchart of the steps of operating a boot module in a cross-subnet-nodes network node device detection method according to an embodiment of the invention. As shown in FIG. 3, upon providing a boot module in each respective node device network node devices (including servers and all the built-in devices) in a subnet of a network, and when desiring to obtain an IP address by a network node device, it is required to utilize this boot module. Then, the boot module can be used for the mutual identification and recording for all the network node devices in a subnet. As such, its major functions can be classified into the following four aspects:

(1) Activating a network node device of a subnet node as a Registry Server, that is used to record the registry information of all the network node devices in a subnet. Please refer to the FIG. 3 for the steps of the operation flow: transmitting multi-cast registry packets (step S3)→determining if the registry server is present (step S4)→if the answer is negative, activating the network node device as a registry server to start registering and monitoring (step S8)=receiving a registry command (step S9)→recording the registry information of other network node devices (step S10).

(2) In case that a registry server is already present, transmitting the registry information of the network node device itself to the registry server. Please refer to FIG. 3 for the steps of the operation flow: transmitting the multi-cast registry packets (step S3)→determining if the registry server is present (step S4)→in case the answer is positive, obtaining the IP address of the registry server (step S5)→determining if receiving a command for searching the IP address of the registry server sent from the discovery server (step S6).

(3) receiving a command for searching the IP address of the registry server sent from the discovery server, and transmitting the IP address of the registry server in the subnet thus obtained back to the discovery server. Please refer to FIG. 3 for the steps of the operation flow: ordering to monitor (step S1)→receiving a search command (step S2)→transmitting the multi-cast registry packets (step S3)→determining if the registry server is present (step S4)→in case the answer is positive, obtaining the IP address of the registry server (step S5)→determining if receiving a command for searching the IP address of the registry server sent from the discovery server (step S6)→upon receiving the command for searching the IP address of the registry server sent from the discovery server, transmitting the IP address of the registry server in the subnet back to discovery server (step S7).

(4) upon receiving a command for searching the network node device by the registry server, transmitting the registry information of all the network node devices presently recorded to the discovery server. Please refer to FIG. 3 for the steps of the operation flow: transmitting multi-cast registry packets (step S3)→determining if the registry server is present (step S4)→if the answer is negative, activating the network node device as a registry server to start registering and monitoring (step S8)→receiving a command for searching the network node device (step S11)→transmitting the registry information of all the network node devices presently recorded to the discovery server (step S12).

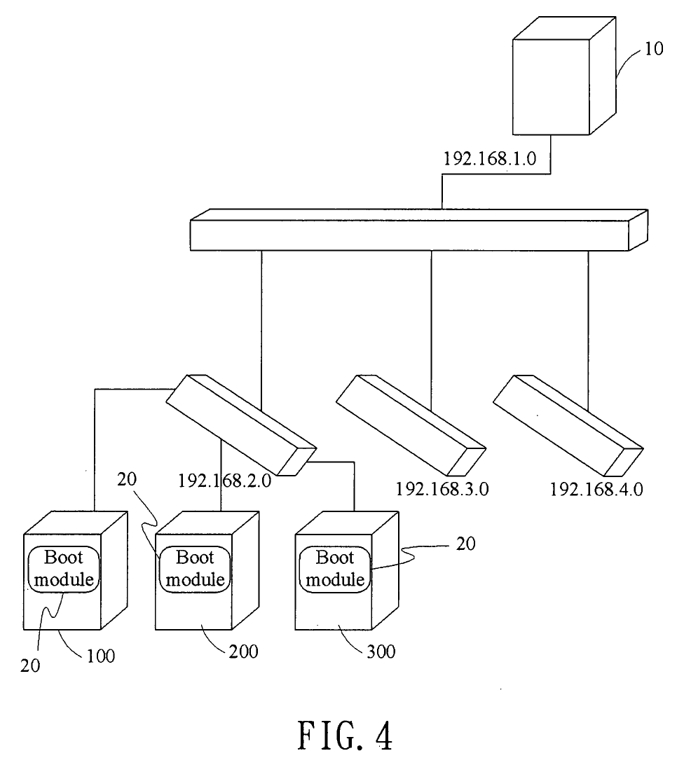

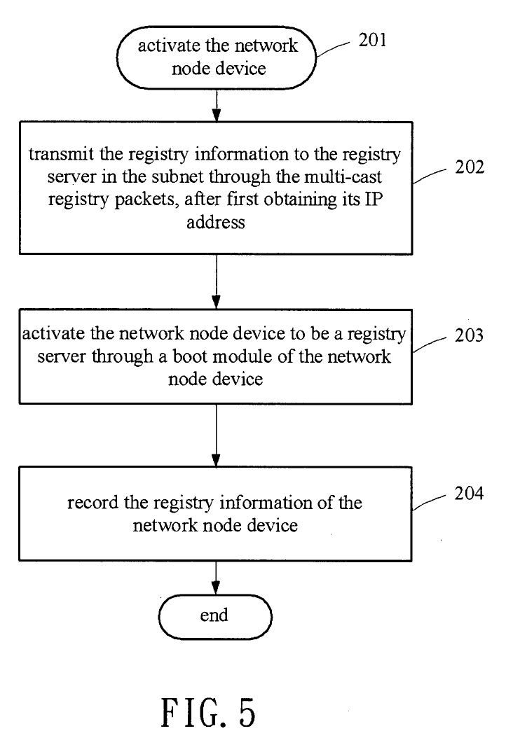

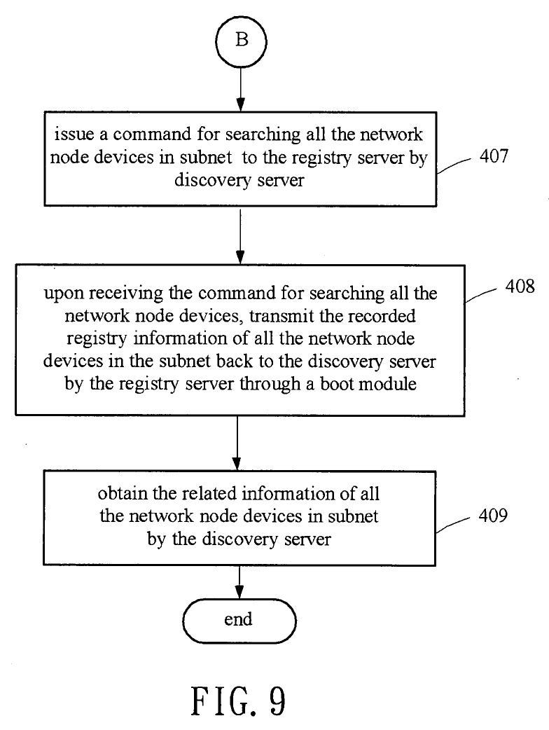

Finally, refer to FIG. 4, FIG. 5, and FIG. 9. FIG. 4 is a system block diagram of the network structure for the implementation of the cross-subnet-nodes network node device detection method according to an embodiment of the invention. FIGS. 5 to 9 show the various groups of the steps of operation flow in carrying out the cross-subnet-nodes network node device detection method according to an embodiment of the invention. As shown in FIG. 4, before implementing the cross-subnet-nodes network node device detection method of the invention in carrying out the search and detection of the various network node devices governed in a subnet 192.168.2.0 of a large scale network environment, each network node devices 100, 200, and 300 is provided with a boot module 20. As such, the search of the network node devices in a subnet by the discovery server 10 is not conducted in a direct search manner for each respective network node devices as based on TCP/IP, instead a new way of search making use of the UDP broadcast technology provided by the cross-subnet-nodes network node device detection method is utilized. The actual steps in realizing this new way of search are described in detail as follows with reference to FIGS. 5 to 9.

Firstly, as shown in FIG. 5, upon activating the network node device 100 in a subnet 192.168.2.0 (step S201), transmitting the registry information to the registry server in the subnet through the multi-cast registry packets, after first obtaining its IP address (step S202); activating the network node device 100 to be a registry server through a boot module 20 of the network node device 100, since at present there does not exist a registry server in subnet 192.168.2.0 (step S203); recording the registry information of the network node device 100 (step S204), wherein, the recorded registry information includes: IP address of network node device 100, the type of the node, and the type of the supportive network connection protocol.

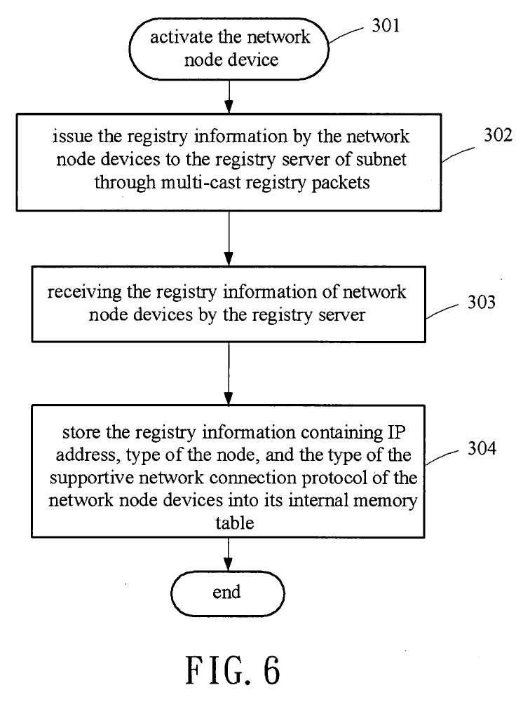

Next, as shown in FIG. 6, upon activating the network node devices 200 and 300 (step S301), issuing the registry information by the network node devices 200 and 300 to the registry server (namely, network node device 100) of subnet 192.168.2.0 through multi-cast registry packets, after obtaining their respective IP addresses (step S302); upon receiving the registry information of network node devices 200 and 300 by the registry server (namely, network node device 100)(step S303); storing the registry information containing IP address, type of the node, and the type of the supportive network connection protocol of the network node devices 200 and 300 into its internal memory table by the registry server (namely, network node device 100) (step S304).

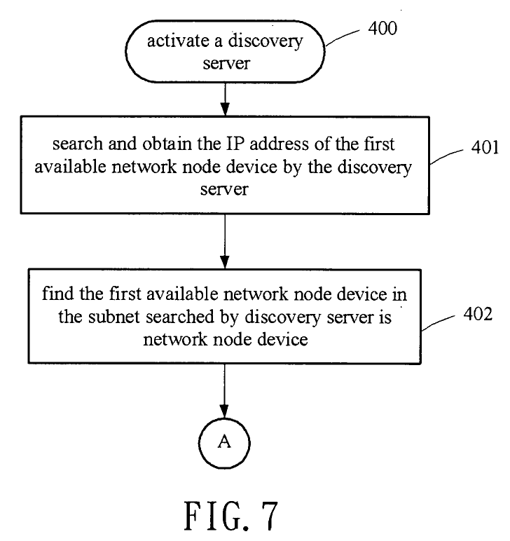

Then, as shown in FIG. 7, upon activating a discovery server 10 (step S400), and when it is required to search all the network node devices in subnet 192.168.2.0, searching and obtaining the IP address of the first available network node device by the discovery server 10 by means of ICMP echo check procedure (step S401); finding the first available network node device in the subnet searched by discovery server 10 is network node device 200 (step S402).

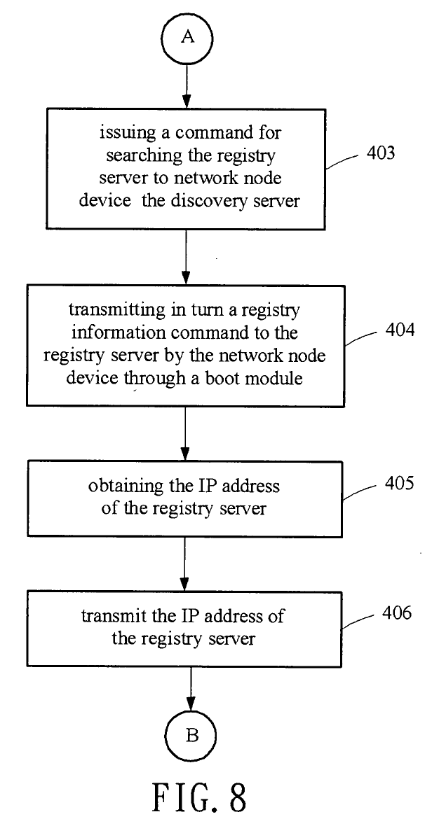

Subsequently, as shown in FIG. 8, issuing a command for searching the registry server to network node device 200 by the discovery server 10 (step S403); transmitting in turn a registry information command to the registry server by the network node device 200 through a boot module 20 (step S404); and obtaining the IP address of the registry server (namely, network node device 100) (step S405); then, transmitting the IP address of the registry server (namely, network node device 100) back to the discovery server 10 (step S406).

Finally, as shown in FIG. 9, issuing a command for searching all the network node devices in subnet 192.168.2.0 to the registry server (namely, network node device 100) by discovery server 10 (step S407); upon receiving the command for searching all the network node devices, transmitting the recorded registry information of all the network node devices in the subnet back to the discovery server 10 by the registry server (namely, network node device 100) through a boot module 20 (step S408); upon obtaining the related information of all the network node devices (including network node devices 100, 200,and 300) in subnet 192.168.2.0 by the discovery server 10 (step S409), terminating the search and detection of network node devices in subnet 192.168.2.0.

Summing up the above, through the application of the cross-subnet-nodes network node device detection method of the invention, a discovery server 10 may obtain the pertinent information of all the network node devices in a subnet in a time period originally required in executing one or two search commands in the conventional manner, thus providing a rapid network node device detection method for a multi-subnet large scale network environment, hereby increasing the search efficiency and reducing the waiting time of the user significantly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cross-subnet-nodes network node device detection method, that is capable of performing rapid search of network node devices on a plurality of subnet nodes in any one of subnets of a large scale network environment, comprising the following steps:
disposing a boot module in a network node device on each respective subnet nodes in an arbitrary subnet of a network;
activating the network node device of a first subnet node in the subnet, and activating the network node device to be a registry server by means of the boot module of the network node device, and recording registry information of the network node device;
activating the network node device of other subnet nodes in the subnet, and dispatching the registry information of the network node devices to the registry server of the first subnet node through the boot modules of the network node devices and recording it;
searching and obtaining a IP address of the network node device on a first available subnet node in the subnet through a check process when the discovery server is required to search all the network node devices in the subnet;
issuing a command for searching registry server to the network node device of the first available subnet node by the discovery server, issuing a registry information command in turn by the network node device on the first available subnet node through the boot module, and obtaining a IP address of the registry server and sending it back to the discovery server; and
issuing a command for searching all the network node devices in the subnet to the registry server by the discovery server, and transmitting the registry information of all the network node devices in the subnet to the discovery server by the registry server through the boot module.

2. The cross-subnet-nodes network node device detection method as claimed in claim 1, wherein the registry information of the network node devices of the respective subnet nodes includes information of IP address of the network node device, type of the node, and type of supportive network connection protocol.

3. The cross-subnet-nodes network node device detection method as claimed in claim 1, wherein the registry information of the network node devices of the respective subnet nodes is transmitted through Multi-Cast Registry Packets.

4. The cross-subnet-nodes network node device detection method as claimed in claim 1, wherein the registry information of the network node devices of the other subnet nodes is recorded in an internal memory table of the registry server of the first subnet node.

5. The cross-subnet-nodes network node device detection method as claimed in claim 1, wherein the check procedure is an echo check procedure of Internet Control Message Protocol (ICMP).
